(19) United States
(12) Patent Application Publication
(10) Pub. No.: US 2016/0219102 A1
(43) Pub. Date: Jul. 28, 2016

(54) DEVICE MANAGEMENT SYSTEM AND AUTOMATIC DEVICE MANAGEMENT SYSTEM

(71) Applicant: KYOCERA Document Solutions Inc., Osaka (JP)

(72) Inventors: Koki NAKAJIMA, Osaka-shi (JP); Takeshi ARAYA, Osaka-shi (JP); Toru YASUI, Osaka-shi (JP); Takumi NAKAMURA, Osaka-shi (JP); Hiromasa AKAMATSU, Osaka-shi (JP)

(73) Assignee: KYOCERA Document Solutions Inc., Osaka (JP)

(21) Appl. No.: 15/001,404

(22) Filed: Jan. 20, 2016

(30) Foreign Application Priority Data
Jan. 23, 2015 (JP) 2015-010941
Jan. 23, 2015 (JP) 2015-010942

(51) Int. Cl. H04L 29/08

(52) U.S. Cl. CPC H04L 67/1044; H04L 67/142

(57) ABSTRACT

A device management system for managing a plurality of image forming apparatuses includes a management state determination section and a management state notification section. The management state determination section determines whether or not each of the image forming apparatuses is appropriately managed based on information from an application for managing the image forming apparatuses. The management state notification section sends to a specified address an inappropriate management notification indicating that a given one of the image forming apparatuses is not appropriately managed. The management state notification section sends out the inappropriate management notification when the management state determination section determines that a given one of the image forming apparatuses is not appropriately managed (S135, S140, and S144).

### INCORPORATION BY REFERENCE

The present application claims priority under 35 U.S.C. §119 to Japanese Patent Application No. 2015-010941, filed on Jan. 23, 2015 and Japanese Patent Application No. 2015-010942, filed on Jan. 23, 2015. The contents of these applications are incorporated herein by reference in their entirety.

### BACKGROUND

The present disclosure relates to a device management system and an automatic device management system that each manage a plurality of devices.

A known system for managing a plurality of devices monitors states of devices that are located at remote locations.

### SUMMARY

A device management system for managing a plurality of devices according to a first aspect of the present disclosure includes a management state determination section and a management state notification section. The management state determination section determines whether or not each of the devices is appropriately managed based on information from an application for managing the devices. The management state notification section sends to a specified address an inappropriate management notification indicating that a given one of the devices is not appropriately managed. The management state notification section sends out the inappropriate management notification when the management state determination section determines that a given one of the devices is not appropriately managed.

An automatic device management system according to a second aspect of the present disclosure includes the device management system according to the first aspect of the present disclosure and a control system. The control system controls the device management system. The device management system further includes a group management section. The group management section manages the devices, groups to which the devices belong, and a hierarchical structure of the groups. Upon the management state determination section determining that a given one of the devices is not appropriately managed, the device management system sends the inappropriate management notification to the control system instead of sending the inappropriate management notification to the specified address. Upon receiving the inappropriate management notification, the control system causes the group management section to change a group to which an inappropriately managed device belongs from an inappropriately managed device's group to a higher group. The inappropriately managed device is the given one of the devices. The inappropriately managed device's group is a group to which the inappropriately managed device belongs. The higher group is a group to which the inappropriately managed device's group belongs.

An automatic device management system according to a third aspect of the present disclosure includes a device management system and a control system. The device management system manages a plurality of devices. The control system controls the device management system. The device management system includes a management state determination section and a group management section. The management state determination section determines whether or not each of the devices is appropriately managed based on information from an application for managing the devices. The group management section manages the devices, groups to which the devices belong, and a hierarchical structure of the groups. Upon the management state determination section determining that a given one of the devices is not appropriately managed, the control system causes the group management section to change a group to which an inappropriately managed device belongs from an inappropriately managed device's group to a higher group. The inappropriately managed device is the given one of the devices. The inappropriately managed device's group is a group to which the inappropriately managed device belongs. The higher group is a group to which the inappropriately managed device's group belongs.

### BRIEF DESCRIPTION OF THE DRAWINGS

FIG. 1 is a block diagram of a system according to a first embodiment of the present disclosure.

FIG. 2 is a diagram illustrating an example of groups to which image forming apparatuses illustrated in FIG. 1 belong.

FIG. 3 is a flowchart showing a first half of an operation of a device management system illustrated in FIG. 1 for determining whether or not each image forming apparatus is appropriately managed.

FIG. 4 is a flowchart showing a last half of the operation of the device management system illustrated in FIG. 1 for determining whether or not each image forming apparatus is appropriately managed.

FIG. 5 is a flowchart showing a first half of an operation of the device management system illustrated in FIG. 1 upon determination that an image forming apparatus is not appropriately managed.

FIG. 6 is a flowchart showing a last half of the operation of the device management system illustrated in FIG. 1 upon determination that an image forming apparatus is not appropriately managed.

FIG. 7 is a diagram illustrating an example of an inappropriate management notification that is sent to an address of a group administrator by a management state notification section illustrated in FIG. 1.

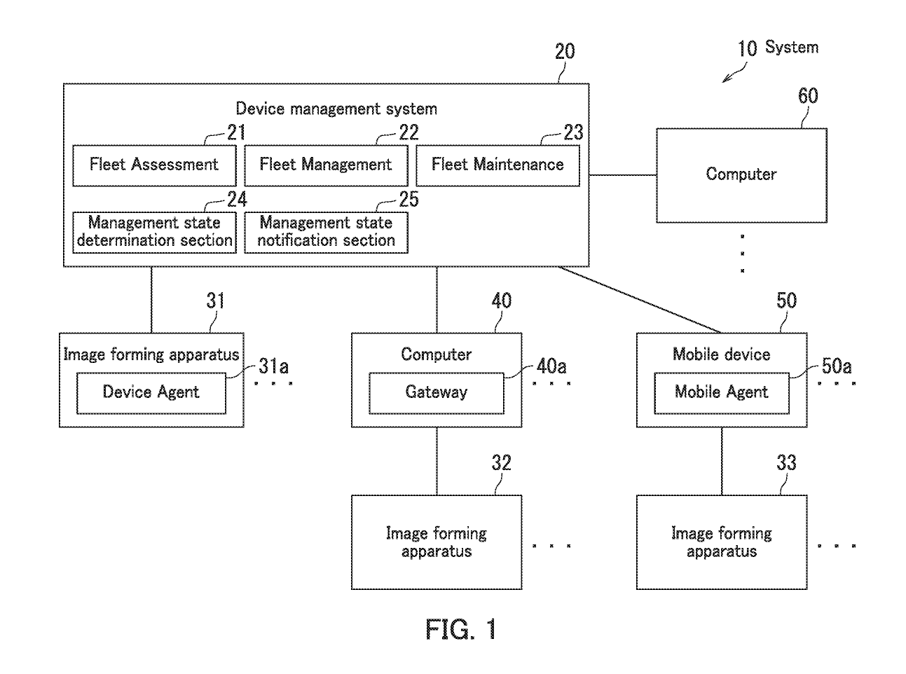

FIG. 1 is a diagram illustrating an example of an inappropriate management notification including a warning that is sent to an address of a group administrator by the management state notification section illustrated in FIG. 1.

FIG. 9 is a diagram illustrating an example of an inappropriate management notification that is sent to an address of a higher group administrator by the management state notification section illustrated in FIG. 1.

FIG. 10 is a block diagram of a system according to a second embodiment of the present disclosure.

FIG. 11 is a diagram illustrating a communication model between a device management system and a workflow service illustrated in FIG. 10.

FIG. 12 is a flowchart showing a first half of an example of an operation of the device management system illustrated in FIG. 10 in a situation in which the device management system is automated and the device management system determines that an image forming apparatus is not appropriately managed.

FIG. 13 is a flowchart showing a last half of the example of the operation of the device management system illustrated in FIG. 10 in a situation in which the device management system is automated and the device management system determines that an image forming apparatus is not appropriately managed.

FIG. 14 is a flowchart showing an example of an operation of the workflow service illustrated in FIG. 10 in a situation in which a specific notification from the device management system is received.

FIG. 15 is a flowchart showing an example of an operation of the workflow service illustrated in FIG. 10 in a situation in which an application referred to as Fleet Management is caused to change a group to which an inappropriately managed device belongs.

### DETAILED DESCRIPTION

Hereinafter, a first embodiment and a second embodiment of the present disclosure will be described with reference to the accompanying drawings.

### First Embodiment

First, configuration of a system 10 according to the first embodiment will be described.

FIG. 1 is a block diagram of the system 10 according to the first embodiment.

As illustrated in FIG. 1, the system 10 includes a device management system 20 that manages a plurality of devices, that is, image forming apparatuses herein. The device management system 20 is implemented by at least one computer. For example, the device management system 20 is administered by a manufacturer of the image forming apparatuses.

The device management system 20 can execute the following applications for managing the image forming apparatuses: Fleet Assessment 21, Fleet Management 22, and Fleet Maintenance 23. The Fleet Assessment 21 is for example an application that diagnoses states of groups to which the image forming apparatuses belong. The states of the groups for example include an operational status and a maintenance status of the image forming apparatuses. The Fleet Management 22 is an application that manages the image forming apparatuses. The Fleet Management 22 constitutes a group management section that manages the groups to which the image forming apparatuses belong. The Fleet Maintenance 23 is an application that performs maintenance on the image forming apparatuses located at remote locations.

The device management system 20 includes functions as a management state determination section 24 and a management state notification section 25 that are implemented through execution of a specific program. The management state determination section 24 determines whether or not each image forming apparatus is appropriately managed based on information from the application for managing the image forming apparatuses. Upon the management state determination section 24 determining that an image forming apparatus is not appropriately managed, the management state notification section 25 sends to a specified address an inappropriate management notification indicating that the image forming apparatus is not appropriately managed.

The system 10 includes a plurality of image forming apparatuses such as image forming apparatuses 31, 32, and 33. The image forming apparatuses are for example multifunction peripherals (MFP), printers, copiers, and scanners. Each of the plurality of image forming apparatuses is located at a location of a user of the image forming apparatus.

Each image forming apparatus 31 can execute an application referred to as Device Agent 31a for managing the image forming apparatus 31 itself. The Device Agent 31a is an application that collects information needed for image forming apparatus management (hereinafter, referred to as “Fleet Data”) from the image forming apparatus 31 itself and sends the collected Fleet Data to the device management system 20 via a network such as the internet. The Fleet Data includes information indicating the state of the image forming apparatus. The information indicating the state of the image forming apparatus is for example that the image forming apparatus has run out of a recording medium such as paper, that the image forming apparatus has run out of a toner of a certain color, that a cover of the image forming apparatus has been opened, that the image forming apparatus has a malfunction, or that the image forming apparatus has been turned on. The system 10 includes a plurality of image forming apparatuses that are similar to the image forming apparatuses 31.

The system 10 includes computers 40. The computers 40 are for example personal computers (PC) that manage a plurality of image forming apparatuses such as the image forming apparatuses 32. The computers 40 are located at locations of users of the image forming apparatuses. The computers 40 can each execute an application referred to as Gateway 40a for managing the corresponding image forming apparatus. The Gateway 40a collects Fleet Data from the corresponding image forming apparatus and sends the collected Fleet Data to the device management system 20 via a network such as the internet. The system 10 includes a plurality of computers that are similar to the computers 40.

The system 10 includes mobile devices 50 such as smartphones and tablet computers that are respectively communicable with image forming apparatuses such as the image forming apparatuses 33. Each mobile device 50 communicates with the corresponding image forming apparatus through short-range communication such as Bluetooth (registered Japanese trademark). The mobile device 50 is carried by a device administrator. The device administrator is for example a service technician serving as an administrator of the image forming apparatus. The mobile device 50 can execute an application referred to as Mobile Agent 50a for managing the image forming apparatus. The Mobile Agent 50a. collects Fleet Data from the image forming apparatus through short-range communication and sends the collected Fleet Data to the device management system 20 via a network such as the third generation of mobile telecommunications technology (3G). The system 10 includes a plurality of mobile devices that are similar to the mobile devices 50.

The system 10 includes computers 60. The computers 60 are PCs that are used by either device administrators or group administrators who are administrators of groups to which image forming apparatuses belong. Each computer 60 is located at a location of a user of the computer 60 who is either the device administrator or the group administrator. The computers 60 can use the Fleet Assessment 21, the Fleet Management 22, and the Fleet Maintenance 23 that are provided by the device management system 20 through communication with the device management system 20 via a network such as the internet. The system 10 includes a plurality of computers which play a role similar to that of the computer 60. The system 10 includes a plurality of computers that are similar to the computers 60.

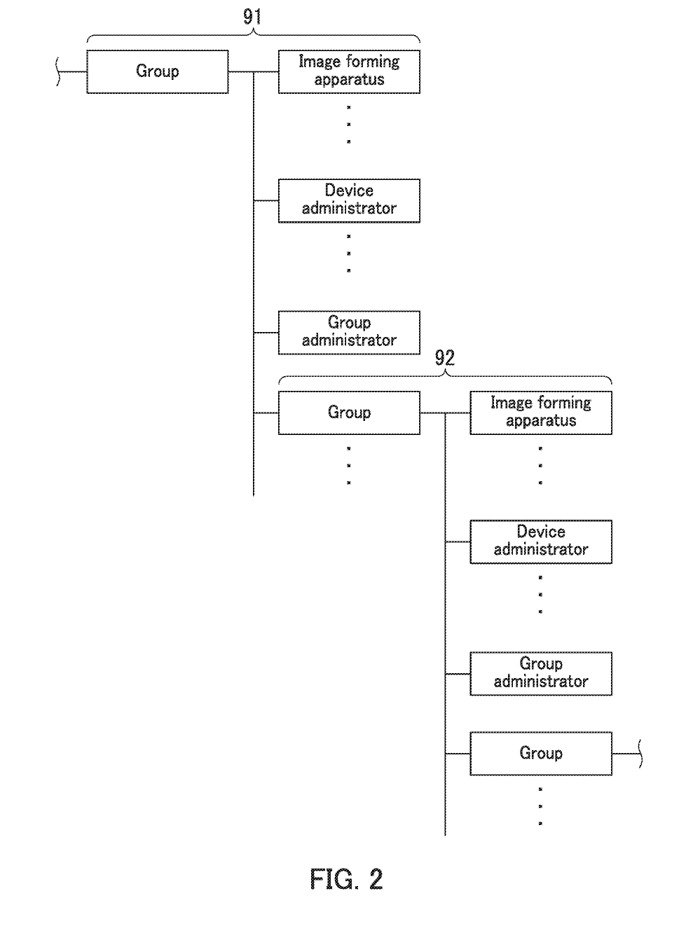

FIG. 2 is a diagram illustrating an example of the groups to which the image forming apparatuses belong.

As illustrated in FIG. 2, each group has a group administrator. Each group administrator can register or delete an image forming apparatus, a device administrator, and a group in or from the group to which the group administrator belongs. A plurality of image forming apparatuses, a plurality of device administrators, and a plurality of groups may belong to one group. Each group administrator can register or change which device administrator manages which image forming apparatus for the image forming apparatuses and the device administrators belonging to the group to which the group administrator belongs. A device administrator refers to an administrator of at least one image forming apparatus belonging to the group to which the device administrator belongs.

The groups are arranged in a hierarchical structure. In FIG. 2, for example, a group 91 is a group higher than a group 92. The highest group is for example of a vendor exclusive for a manufacturer of the image forming apparatuses. The lowest group is for example of a user of an image forming apparatus. No group or one or more levels of groups are present between the highest group and the lowest group. A group that may be present between the highest group and the lowest group is for example of a vendor that is not exclusive for the manufacturer of the image forming apparatuses (hereinafter, referred to as “non-exclusive vendor”).

The Fleet Management 22 (see FIG. 1) manages: groups; image forming apparatuses, device administrators, and group administrators belonging to the groups; and the hierarchical structure of the groups.

Next, an operation of the system 10 will be described.

First, an operation of the device management system 20 for determining whether or not each image forming apparatus is appropriately managed will be described.

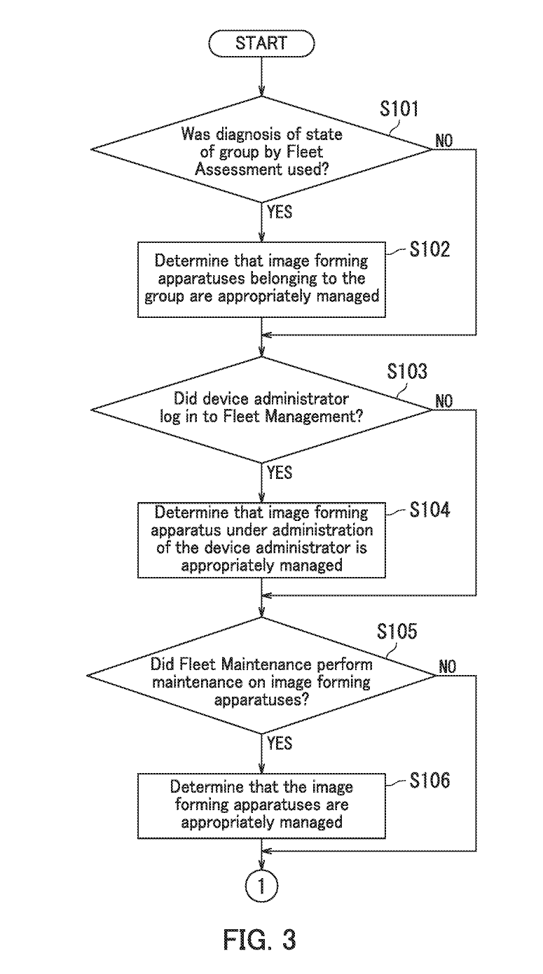

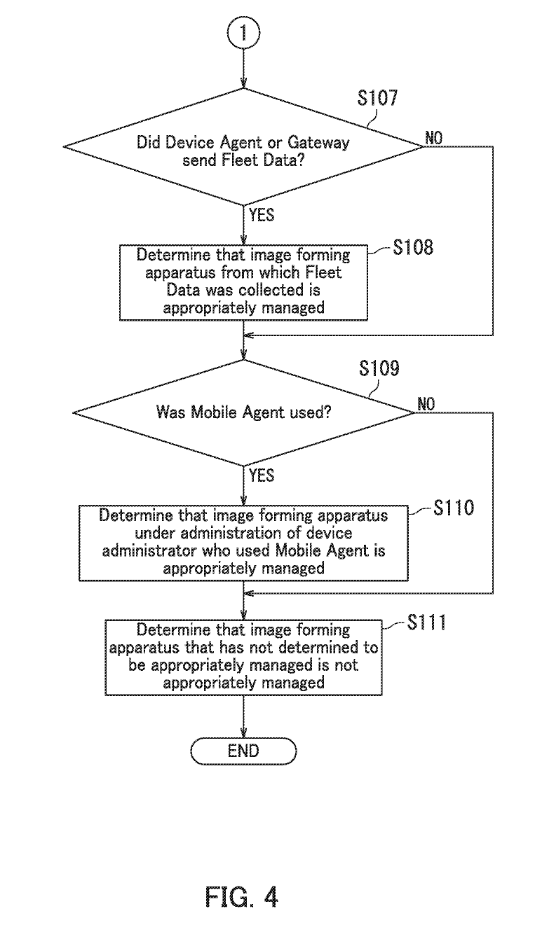

FIG. 3 is a flowchart showing a first half of the operation of the device management system 20 for determining whether or not each image forming apparatus is appropriately managed. FIG. 4 is a flowchart showing a last half of the operation of the device management system 20 for determining whether or not each image forming apparatus is appropriately managed.

As shown in FIG. 3, the management state determination section 24 of the device management system 20 determines whether or not a diagnosis of the state of a group by the Fleet Assessment 21 was used during a past specific period of time from the present (S101).

Upon determining in S101 that the diagnosis of the state of the group by the Fleet Assessment 21 was used, the management state determination section 24 determines that the image forming apparatuses belonging to the group are appropriately managed (S102).

Upon the management state determination section 24 determining in S101 that the diagnosis of the state of the group by the Fleet Assessment 21 was not used or upon completion of S102, the operation proceeds to S103. The management state determination section 24 determines whether or not each device administrator logged in to the Fleet Management 22 during a past specific period of time from the present (S103).

Upon determining in S103 that the device administrator logged in to the Fleet Management 22, the management state determination section 24 determines that the image forming apparatus under administration of the device administrator is appropriately managed (S104).

Upon the management state determination section 24 determining in S103 that the device administrator did not log in to the Fleet Management 22 or upon completion of S104, the operation proceeds to S105. The management state determination section 24 determines whether or not the Fleet Maintenance 23 performed maintenance on the image forming apparatuses during a past specific period of time from the present (S105).

Upon determining in S105 that the Fleet Maintenance 23 performed maintenance on the image forming apparatuses, the management state determination section 24 determines that the image forming apparatuses are appropriately managed (S106).

Upon the management state determination section 24 determining in S105 that the Fleet Maintenance 23 did not perform maintenance on the image forming apparatuses or upon completion of S106, the operation proceeds to S107. The management state determination section 24 determines whether or not each Device Agent 31a or each Gateway 40a sent Fleet Data to the device management system 20 during a past specific period of time from the present (S107).

Upon determining in S107 that the Device Agent 31a or the Gateway 40a sent Fleet Data to the device management system 20, the management state determination section 24 determines that the image forming apparatus from which the Fleet Data was collected is appropriately managed (S108).

Upon the management state determination section 24 determining in S107 that the Device Agent 31a or the Gateway 40a did not send Fleet Data to the device management system 20 or upon completion of S108, the operation proceeds to S109. The management state determination section 24 determines whether or not each Mobile Agent 50a was used during a past specific period of time from the present (S109).

Upon determining in S109 that the Mobile Agent 50a was used, the management state determination section 24 determines that the image forming apparatus under administration of the device administrator who used the Mobile Agent 50a is appropriately managed (S110).

Upon the management state determination section 24 determining in S109 that the Mobile Agent 50a was not used or upon completion of S110, the operation proceeds to S111. The management state determination section 24 determines that an image forming apparatus not determined to be “appropriately managed” in any of S102, S104, S106, S108, and S110 is not appropriately managed (S111), whereupon the operation shown in FIGS. 3 and 4 comes to an end.

Next, an operation of the device management system 20 when the device management system 20 determines that an image forming apparatus is not appropriately managed will be described.

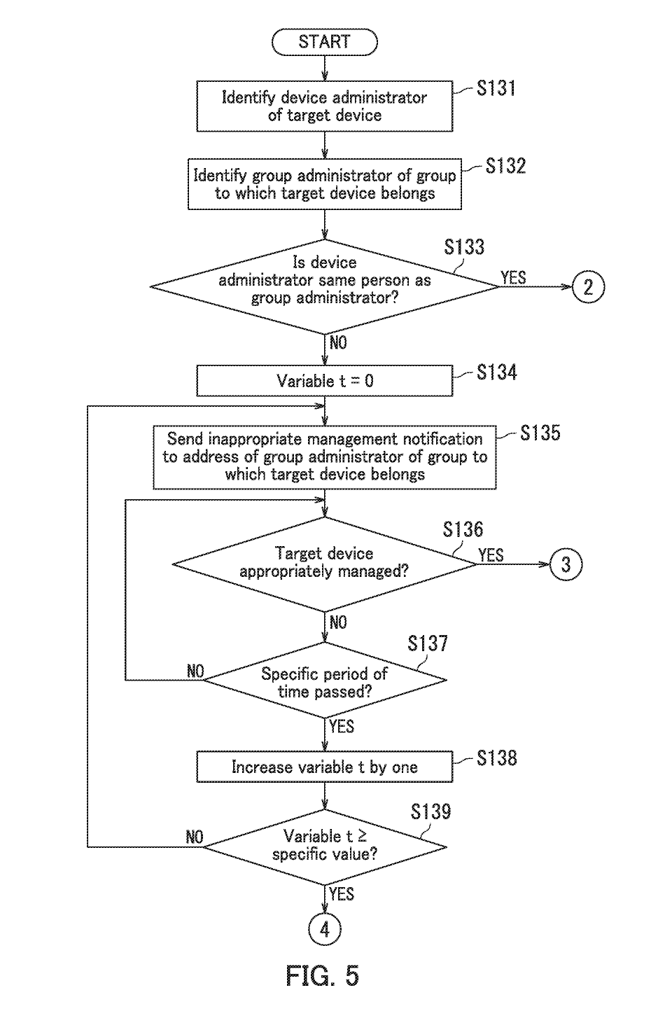

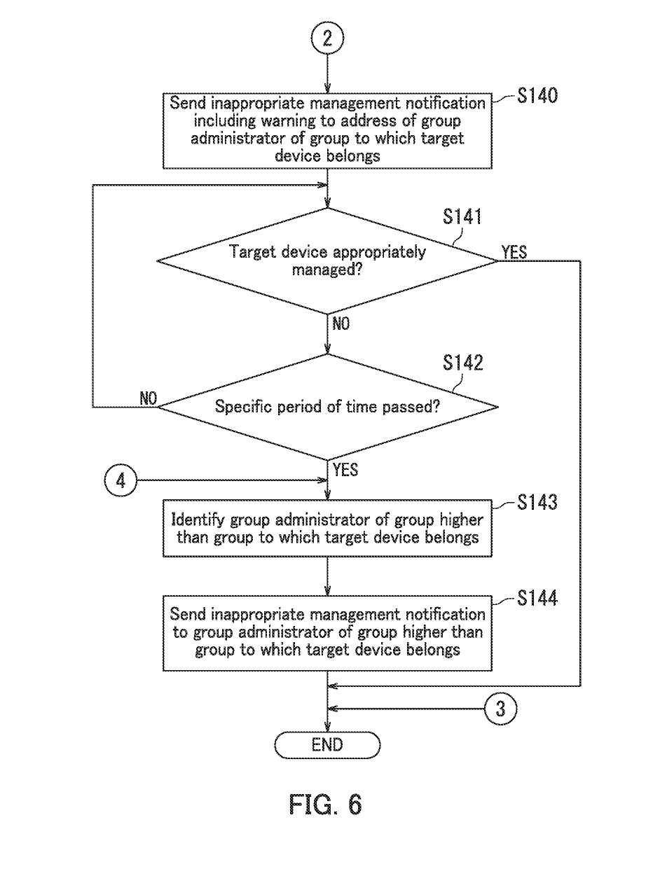

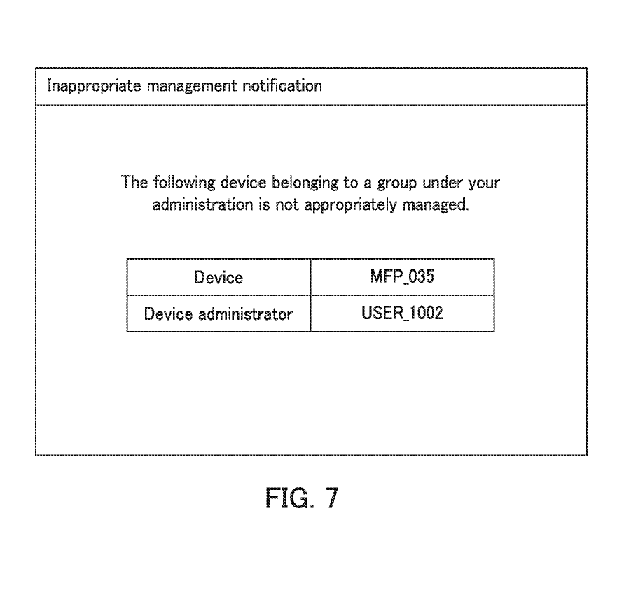

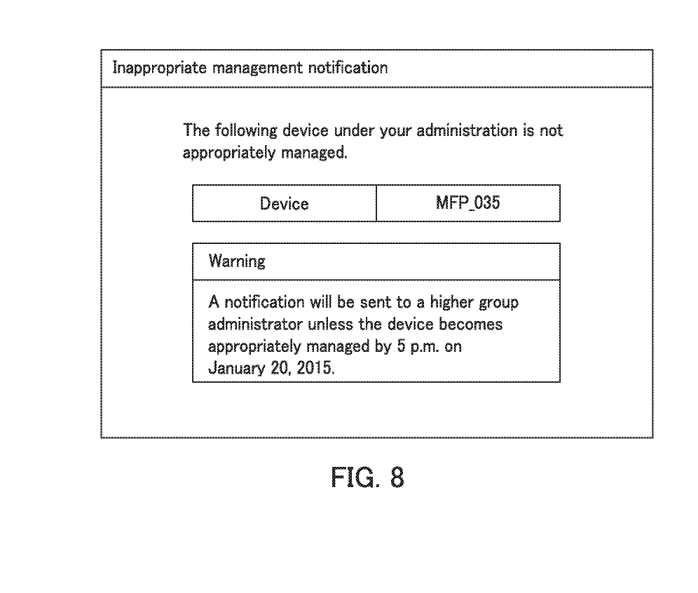

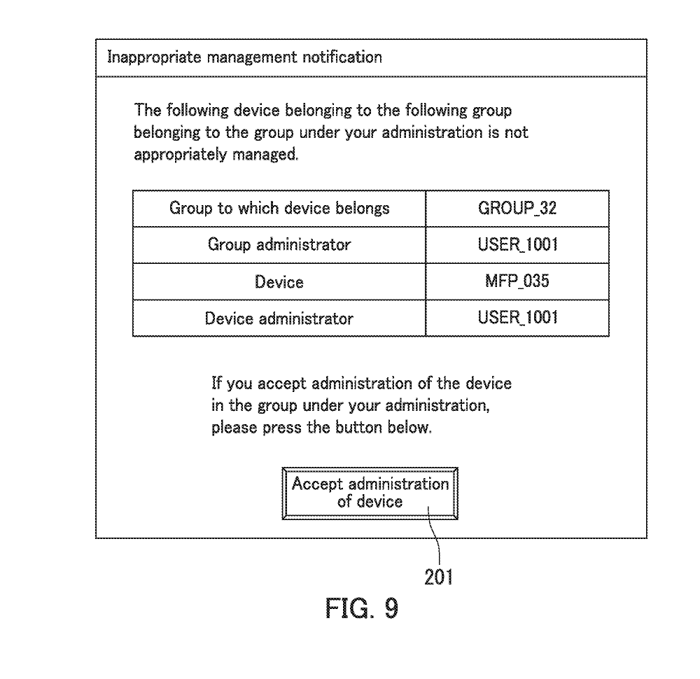

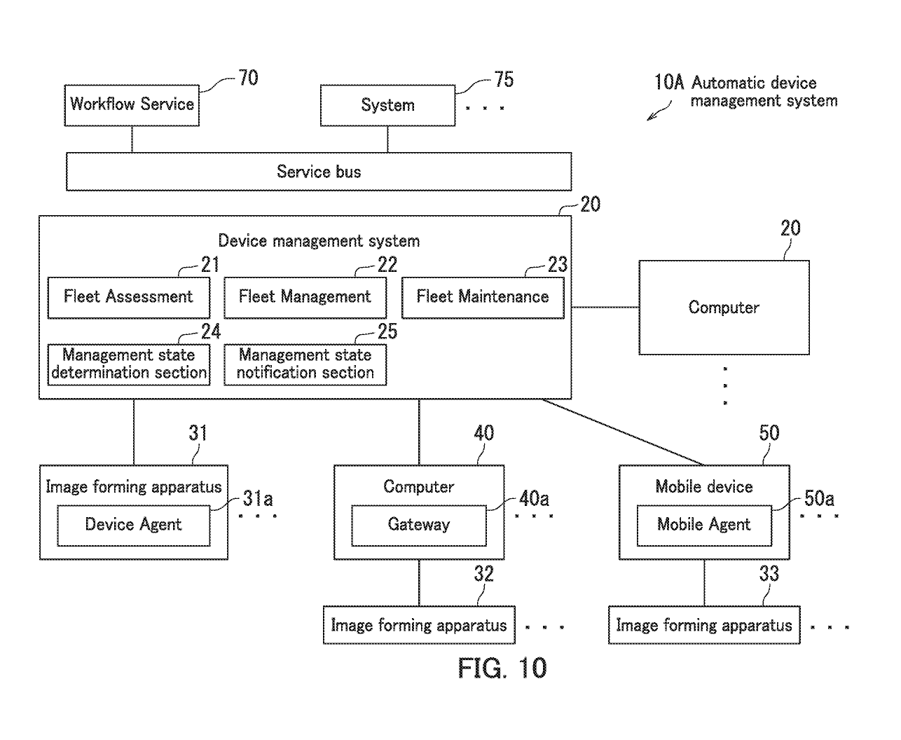

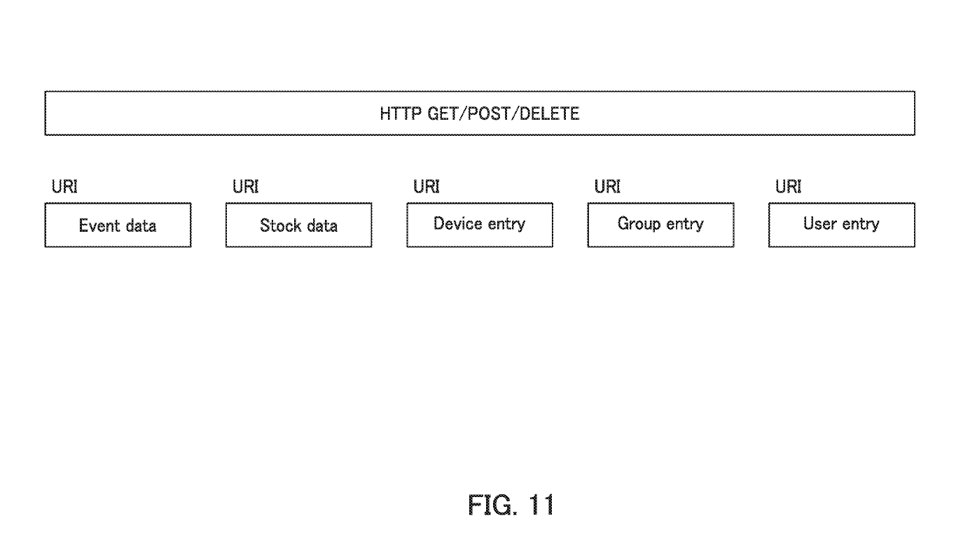

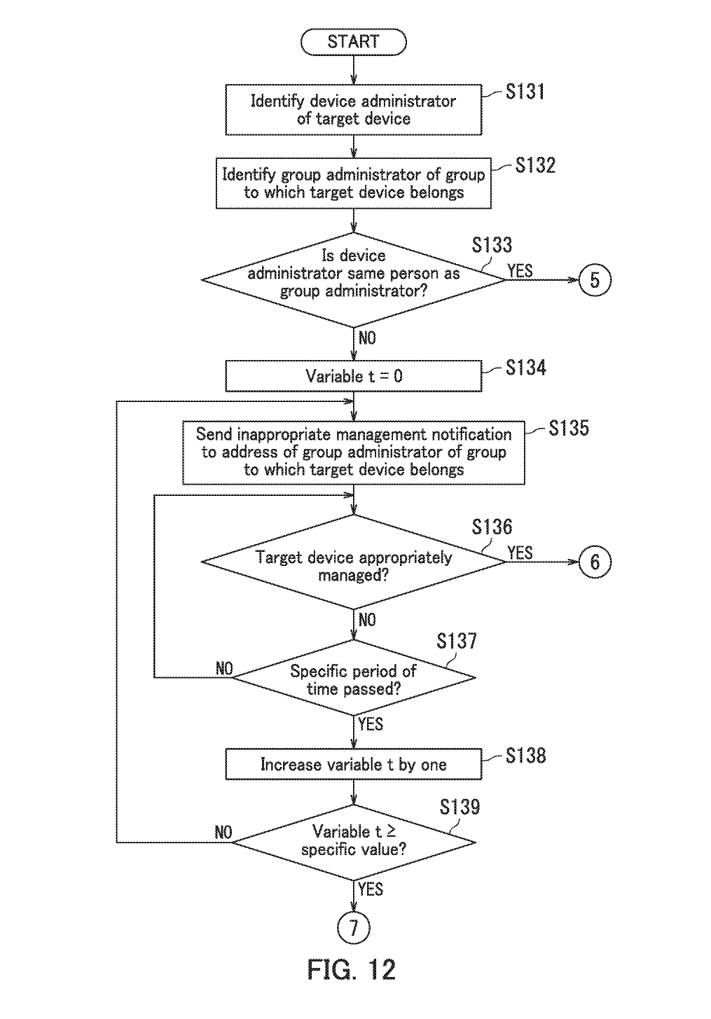

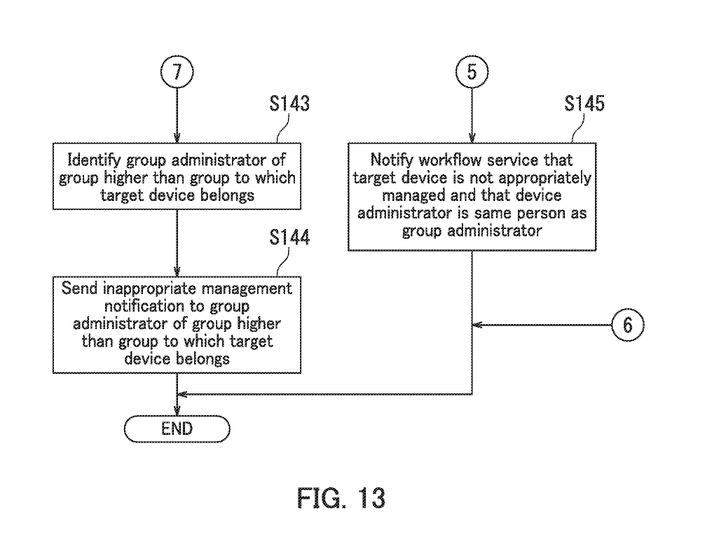

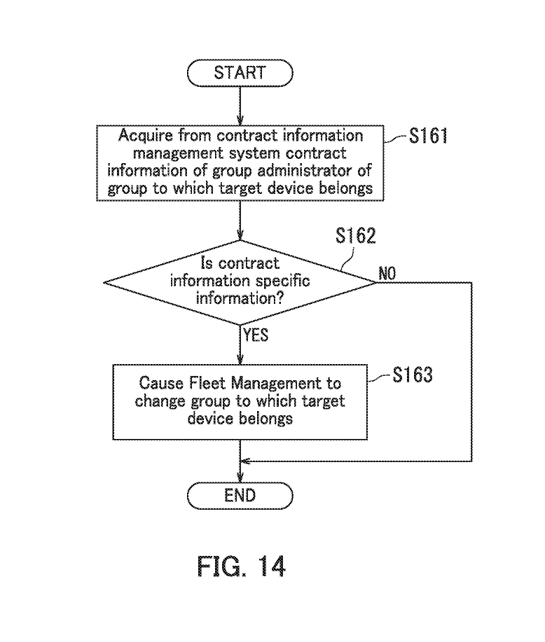

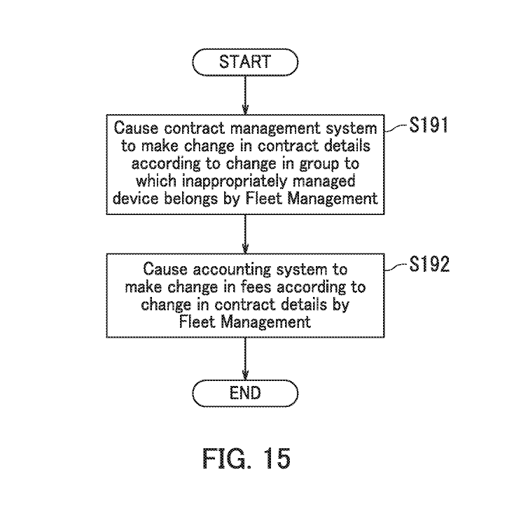

FIG. 5 is a flowchart showing a first half of the operation of the device management system 20 when the device management system 20 determines that an image forming apparatus is not appropriately managed. FIG. 6 is a flowchart showing a last half of the operation of the device management system 20 when the device management system 20 determines that an image forming apparatus is not appropriately managed. FIG. 7 is a diagram illustrating an example of an inappropriate management notification that is sent to an address of a higher group administrator by the management state notification section illustrated in FIG. 1. FIG. 8 is a diagram illustrating an example of an inappropriate management notification including a warning that is sent to an address of a group administrator by the management state notification section illustrated in FIG. 1. FIG. 9 is a diagram illustrating an example of an inappropriate management notification that is sent to an address of a higher group administrator by the management state notification section illustrated in FIG. 1.

Upon the management state determination section 24 determining in S111 shown in FIG. 4 that an image forming apparatus is not appropriately managed, the device management system 20 performs an operation shown in FIG. 5 on the image forming apparatus determined to be not appropriately managed (hereinafter, referred to as a “target device”).

As illustrated in FIG. 5, the management state notification section 25 identifies the device administrator of the target device using the Fleet Management 22 (S131).

Next, the management state notification section 25 identifies the group administrator of the group to which the target device belongs using the Fleet Management 22 (S132).

Next, the management state notification section 25 determines whether or not the device administrator identified in S131 is the same person as the group administrator identified in S132 (S133).

Upon the management state notification section 25 determining in S133 that the device administrator identified in S131 is not the same person as the group administrator identified in S132, the operation proceeds to S134. The management state notification section 25 sets a value of a variable t to 0 (S134). The management state notification section 25 sends an inappropriate management notification such as illustrated in FIG. 7 to an address of the group administrator identified in S132 (S135).

Next, the management state determination section 24 performs the same operation as shown in FIGS. 3 and 4 to determine whether or not the target device is appropriately managed based on information from the application for managing the image forming apparatuses (S136).

Upon the management state determination section 24 determining in S136 that the target device is appropriately managed, the operation shown in FIG. 5 comes to an end.

Upon determining in S136 that the target device is not appropriately managed, the management state determination section 24 determines whether or not a specific period of time has passed (S137).

Upon determining in S137 that the specific period of time has not passed, the management state determination section 24 performs S136.

Upon determining in S137 that the specific period of time has passed, the management state determination section 24 increases the value of the variable t by one (S138). The management state determination section 24 determines whether or not the variable t is equal to or greater than a specific value (S139).

Upon determining in S139 that the variable t is not equal to or greater than the specific value, the management state notification section 25 performs S135.

Upon the management state notification section 25 determining in S133 that the device administrator identified in S131 is the same person as the group administrator identified in S132, the operation proceeds to S140 in FIG. 6. The management state notification section 25 sends an inappropriate management notification including a warning such as illustrated in FIG. 8 to an address of the group administrator identified in S132 (S140).

Next, the management state determination section 24 performs the same operation as shown in FIGS. 3 and 4 to determine whether or not the target device is appropriately managed based on information from the application for managing the image forming apparatuses (S141).

Upon the management state determination section 24 determining in S141 that the target device is appropriately managed, the operation shown in FIGS. 5 and 6 comes to an end.

Upon determining in S141 that the target device is not appropriately managed, the management state determination section 24 determines whether or not a specific period of time has passed (S142).

Upon determining in S142 that the specific period of time has not passed, the management state determination section 24 performs S141.

Upon the management state determination section 24 determining in S139 that the variable t is equal to or greater than the specific value or determining in S142 that the specific period of time has passed, the operation proceeds to S143. The management state notification section 25 identifies a group administrator of a group one level higher than the group to which the target device belongs (hereinafter, referred to as a “higher group administrator”) using the Fleet Management 22 (S143).

The management state notification section 25 then sends an inappropriate management notification such as illustrated in FIG. 9 to an address of the higher group administrator identified in S143 (S144). That is, the management state notification section 25 identifies a higher group administrator of a group to which the group of the device determined to be not appropriately managed belongs using the Fleet Management 22 when the management state determination section 24 still determines that the device determined to be not appropriately managed is not appropriately managed even after the inappropriate management notification has been sent to, as the specified address, the address of the administrator of the group of the device several times. The management state notification section 25 then sends the inappropriate management notification to, as the specified address, the address of the higher group administrator identified using the Fleet Management 22. As illustrated in FIG. 9, the management state notification section 25 includes a device transfer button 201 serving as a device transfer instruction accepting section in the inappropriate management notification to be sent in S144. The device transfer button 201 is a button for accepting an instruction to transfer the target device to the group one level higher than the group to which the target device belongs. Upon determining that the target device needs to be transferred to the group one level higher than the group to which the target device belongs as a result of reading the inappropriate management notification sent in S144, the higher group administrator identified in S143 can press the device transfer button 201. Upon determining that the target device does not need to be transferred to the group one level higher than the group to which the target device belongs as a result of reading the inappropriate management notification sent in S144, the higher group administrator identified in S143 can ignore the device transfer button 201. The higher group administrator for example determines that the target device does not need to be transferred when a person identified in the inappropriate management notification as the device administrator of the target device is transferred to a different section and therefore is no longer the device administrator of the target device in an organization. Upon the device transfer button 201 being pressed, that is, upon the instruction to transfer the target device being accepted, the Fleet Management 22 transfers the target device to the group one level higher than the group to which target device belongs.

Upon the management state notification section 25 completing S144, the operation shown in FIGS. 5 and 6 comes to an end.

As described above, the device management system 20 determines whether or not each image forming apparatus is appropriately managed based on information from an application for managing the image forming apparatus (S111). Upon determining that an image forming apparatus is not appropriately managed, the device management system 20 sends to a specified address an inappropriate management notification indicating that the image forming apparatus is not appropriately managed (S135, S140, and S144), that is, notifies a person involved in the management of the image forming apparatus that the image forming apparatus is not appropriately managed. Thus, the device management system 20 can maintain the image forming apparatus in an appropriately managed state. More specifically, the device management system 20 for example notifies a person involved in the management of the image forming apparatus that the image forming apparatus is not appropriately managed even in a situation in which the image forming apparatus was sold by a non-exclusive vendor and managed by the non-exclusive vendor but is no longer appropriately managed by the non-exclusive vendor. Thus, the device management system 20 can maintain the image forming apparatus in an appropriately managed state. As a result, the image forming apparatus can offer functions such as a printing function to a user of the image forming apparatus appropriately and constantly.

The device management system 20 notifies the group administrator of the group to which the image forming apparatus determined to be not appropriately managed belongs that the image forming apparatus is not appropriately managed (S135 and S140). Hereinafter, the image forming apparatus determined to be not appropriately managed is referred to as an “inappropriately managed device”, the group to which the inappropriately managed device belongs as an “inappropriately managed device's group”, and a group administrator of the inappropriately managed device's group as an “inappropriately managed device's group administrator”. The inappropriately managed device is the target device. More specifically, using the Fleet Management 22, the management state notification section 25 identifies the group administrator of the inappropriately managed device's group to which the inappropriately managed device determined by the management state determination section 24 to be not appropriately managed belongs. The management state notification section 25 then sends the inappropriate management notification to, as the specified address, the address of the group administrator of the inappropriately managed device's group identified using the Fleet Management 22. Thus, it is possible to increase the likelihood that the inappropriately managed device becomes appropriately managed.

In a situation in which the device administrator of the inappropriately managed device (hereinafter, referred to as an “inappropriately managed device administrator”) is the same person as the inappropriately managed device's group administrator (YES in S133), the inappropriately managed device's group administrator is the inappropriately managed device administrator. Merely sending the inappropriate management notification to the address of the inappropriately managed device's group administrator (S135) is not enough to increase the likelihood that the inappropriately managed device becomes appropriately managed. In a situation in which the inappropriately managed device administrator is the same person as the inappropriately managed device's group administrator, therefore, the device management system 20 performs different processes (S140 to S142) from those to be performed in a situation in which the inappropriately managed device administrator is a different person from the inappropriately managed device's group administrator (NO in S133). As a result, it is possible to increase the likelihood that the inappropriately managed device becomes appropriately managed.

The device management system 20 sends the inappropriate management notification to the address of the inappropriately managed device's group administrator a specified number of times (S134 to S139 or S140 to S142) before sending the inappropriate management notification to the address of the group administrator of the higher group to which the inappropriately managed device's group belongs, that is, to the address of the higher group administrator (S144). In a situation in which the inappropriately managed device becomes appropriately managed as a result of the inappropriately managed device's group administrator notified that the device is not appropriately managed, therefore, the inappropriate management notification does not need to be sent to the address of the higher group administrator. Thus, the device management system 20 can reduce burden on the higher group administrator.

Since the device management system 20 notifies the higher group administrator that the image forming apparatus is not appropriately managed (S144), it is possible to increase the likelihood that the inappropriately managed device becomes appropriately managed.

The device management system 20 changes the group to which the inappropriately managed device belongs from the inappropriately managed device's group to the higher group in response to an instruction that is Oven by the higher group administrator to which the inappropriate management notification has been sent in S144. Thus, it is possible to increase the likelihood that the inappropriately managed device becomes appropriately managed.

### Second Embodiment

Next, configuration of an automatic device management system 10A according to a second embodiment will be described. Hereinafter, the second embodiment will be described mainly based on differences compared to the first embodiment. The automatic device management system 10A has the configuration of the system 10 described in the first embodiment and further includes a workflow service 70, a plurality of systems 75, and a service bus 80.

FIG. 10 is a block diagram of the automatic device management system 10A according to the second embodiment.

As illustrated in FIG. 10, the automatic device management system 10A includes the workflow service 70, the systems 75, and the service bus 80. The workflow service 70 is a control system for controlling the device management system 20. None of the systems 75 is the device management system 20 or the workflow service 70.

The systems 75 are for example on-premise servers such as customer relationship management (CRM) and enterprise resource planning (EPR) servers provided as internal servers in a local area network (LAN) that is different from that of the workflow service 70. The CRM/ERP servers may be for example a contract information management system, a contract management system, or an accounting system for managing fees according to details of an image forming apparatus management contract. The contract information management system manages contract information of group administrators. The contract management system manages details of an image forming apparatus management contract. The systems 75 may be connected with the service bus 80 via a virtual private network (VPN).

The service bus 80 controls communication between the device management system 20 and the workflow service 70. The service bus 80 also controls communication between the workflow service 70 and the systems 75.

FIG. 11 is a diagram illustrating a communication model for the device management system 20 and the workflow service 70.

In FIG. 11, event data, stock data, device entry, group entry indicating registered groups, and user entry are in JavaScript Object Notation (JSON) format. The event data for example includes an error event in an image forming apparatus The stock data for example includes usage histories of image forming apparatuses. The device entry indicates registered image forming apparatuses. The user entry indicates registered users.

The device management system 20 and the workflow service 70 communicate with one another via the service bus 80 using the communication model illustrated in FIG. 11. That is, the device management system 20 and the workflow service 70 communicate with one another in a model based on representational state transfer (REST). The workflow service 70 sets a desired workflow by combining the management state determination section 24 and the Fleet Management 22 modeled using REST. The service bus 80 initiates the workflow set at the workflow service 70 in response to a state change at the device management system 20. The service bus 80 coordinates connection for a call that is made at the workflow service 70 to a REST application programming interface (API) and performs translation at a communication protocol level.

The above has described communication between the device management system 20 and the workflow service 70 but also applies to communication between the workflow service 70 and the systems 75. That is, the workflow service 70 can communicate with the systems 75 via the service bus 80.

An operation of the automatic device management system 10A in a situation in which the device management system 20 whose operation is not automated determines that an image forming apparatus is not appropriately managed is the same as the operation of the system 10 according to the first embodiment.

Next, an operation of the automatic device management system 10A in a situation in which the device management system 20 whose operation is automated deter mines that an image forming apparatus is not appropriately managed will be described with reference to FIGS. 5, 6, and 12 to 15. FIG. 12 is a flowchart showing a first half of an example of the operation of the device management system in a situation in which the automated device management system illustrated in FIG. 10 determines that an image forming apparatus is not appropriately managed. FIG. 13 is a flowchart showing a last half of the example of the operation of the device management system in a situation in which the automated device management system illustrated in FIG. 10 determines that an image forming apparatus is not appropriately managed. FIG. 14 is a flowchart showing an example of an operation of the workflow service illustrated in FIG. 10 in a situation in which a notification from the device management system is received. FIG. 15 is a flowchart showing an example of an operation of the workflow service illustrated in FIG. 10 in a situation in which the Fleet Management is caused to change the group to which an inappropriately managed device belongs.

At least some of the processes shown in FIGS. 5 and 6 described in the first embodiment may be replaced with desired processes automated by the workflow service 70.

For example, upon determining in S133 that the device administrator is the same person as the group administrator, the device management system 20 may notify (S145) the workflow service 70 that the target device is not appropriately managed and that the device administrator of the target device is the same person as the group administrator of the group to which the target device belongs as shown in FIGS. 12 and 13 instead of performing S140 to S144 described with reference to FIG. 6. A workflow that is executed when such a notification from the device management system 20 is received is set in the workflow service 70. The workflow service 70 for example acquires, from the contract information management system which is one of the systems 75, contract information of the group administrator of the group to which the target device belongs according to the workflow as shown in FIG. 14 (S161). In a situation in which the contract information acquired by the workflow service 70 includes specific information (YES in S162), the operation proceeds to S163. The specific information for example indicates that there is a change in the contract or payment. The workflow service 70 may cause the Fleet Management 22 to change the group to which the target device belongs, that is, to transfer the target device to a group one level higher than the group to which the target device belongs (S163). In a situation in which there is no change in the contract or payment (NO in S162), on the other hand, the workflow service 70 may not cause the Fleet Management 22 to change the group to which the target device belongs (S163).

Alternatively, a workflow may be set such that the workflow service 70 causes the Fleet Management 22 to change the group to which the target device belongs according to information acquired from another system 75 that is not the contract information management system. Alternatively, a workflow may be set such that the workflow service 70 causes the Fleet Management 22 to change the group to which the target device belongs regardless of information acquired from a system 75.

When the workflow service 70 causes the Fleet Management 22 to change the group to which an image forming apparatus determined by the device management system to be not appropriately managed (hereinafter, referred to as an “inappropriately managed device”), the workflow service 70 may cause a system 75 to perform a specific process according to the change in the group to which the inappropriately managed device belongs by the Fleet Management 22. For example, when the workflow service 70 causes the Fleet Management 22 to change the group to which the inappropriately managed device belongs, the workflow service 70 may cause the contract management system which is one of the systems 75 to make a change in the contract details according to the change in the group to which inappropriately managed device belongs by the Fleet Management 22 as shown in FIG. 15 (S191). To make a change in the contract details for example means to change the group to which the inappropriately managed device belongs (hereinafter, referred to as an “inappropriately managed device's group”) to a higher group to which the inappropriately managed device's group belongs (hereinafter, referred to as a “higher group”) in a maintenance contract for the inappropriately managed device. Furthermore, the workflow service 70 may cause the accounting system which is one of the systems 75 to make a change in fees according to the change in the contract details by the contract management system (S192).

The above has described an example of the operation shown in FIGS. 5 and 6 described in the first embodiment in which the processes to be performed after it is determined in S133 that the device administrator is the same person as the group administrator are replaced with desired processes that are automated by the workflow service 70. Alternatively, in the operation shown in FIGS. 5 and 6, processes other than the processes to be performed after it is determined in S133 that the device administrator is the same person as the group administrator may be replaced with desired processes that are automated by the workflow service 70. For example, in the operation shown in FIGS. 5 and 6, processes after it is determined in S133 that the device administrator is not the same person as the group administrator may be replaced with desired processes that are automated by the workflow service 70. Alternatively, processes after it is determined in S139 that the variable t is equal to or greater than the specific value may be replaced with desired processes that are automated by the workflow service 70. Alternatively, processes after it is determined in S142 that the specific period of time has passed may be replaced with desired processes that are automated by the workflow service 70.

As described above, the device management system 20 in the automatic device management system 10A determines whether or not each image forming apparatus is appropriately managed based on information from an application for managing the image forming apparatuses (S111). Upon the device management system 20 determining that an image forming apparatus is not appropriately managed, the automatic device management system 10A automatically changes the group to which the inappropriately managed device belongs from the inappropriately managed device's group to a higher group (S163). Thus, the automatic device management system 10A can maintain the image forming apparatus in an appropriately managed state. Even in a situation in which an image forming apparatus in the automatic device management system 10A was sold by anon-exclusive vendor and managed by the non-exclusive vendor but is no longer appropriately managed by the non-exclusive vendor, for example, a group higher than the group to which the non-exclusive vendor belongs manages the image forming apparatus. As a result, the image forming apparatus can offer functions such as a printing function to a user of the image forming apparatus appropriately and constantly.

The device management system 20 in the automatic device management system 10A determines whether or not each image forming apparatus is appropriately managed based on information from an application for managing the image forming apparatuses. Upon the device management system 20 determining that an image forming apparatus is not appropriately managed (S111), the group to which the inappropriately managed device belongs is automatically changed from the inappropriately managed device's group to a higher group (S163). It is therefore possible to reduce burden on a user of the device management system 20 that is inflicted in order to maintain the image forming apparatus in an appropriately managed state.

When the automatic device management system 10A automatically changes the group to which the inappropriately managed device belongs (S163), the automatic device management system 10A automatically performs a specific process needed to be performed in a system 75 due to the change in the group to which the inappropriately managed device belongs (S191 and S192). Thus, it is possible to reduce burden on a user of the system 75.

When the automatic device management system 10A automatically changes the group to which the inappropriately managed device belongs (S163), the automatic device management system 10A automatically makes a necessary change in contract details for management of the inappropriately managed device according to the change in the group to which the inappropriately managed device belongs (S191). Thus, it is possible to reduce burden on a user of the contract management system.

When the automatic device management system 10A automatically changes the group to which the inappropriately managed device belongs (S163), the automatic device management system 10A not only automatically makes a necessary change in contract details for management of the inappropriately managed device according to the change in the group to which the inappropriately managed device belongs (S191) but also automatically makes a change in fees according to the change in the contract details for management of the inappropriately managed device (S192). Thus, it is possible to reduce burden on a user of the accounting system.

The automatic device management system 10A changes the group to which an inappropriately managed device belongs (S163) according to information acquired from a system 75 (S161 and S162). Thus, the image forming apparatus management can be performed more appropriately. In particular, the automatic device management system 10A changes the group to which the inappropriately managed device belongs according to contract information of the administrator of the inappropriately managed device's group that is managed by the contract information management system. Thus, the image forming apparatus management can be performed more appropriately.

The devices of the present disclosure are image forming apparatuses in the first and second embodiments but may be any devices other than image forming apparatuses.

What is claimed is:

1. A device management system for managing a plurality of devices, comprising:
a management state determination section configured to determine whether or not each of the devices is appropriately managed based on information from an application for managing the devices; and
a management state notification section configured to send to a specified address an inappropriate management notification indicating that a given one of the devices is not appropriately managed, wherein
the management state notification section sends out the inappropriate management notification when the management state determination section determines that a given one of the devices is not appropriately managed.

2. The device management system according to claim 1, further comprising
a group management section configured to manage the devices, groups to which the devices belong, and group administrators who are administrators of the groups, wherein
the group management section identifies an inappropriately managed device's group administrator of an inappropriately managed device's group to which an inappropriately managed device belongs, the inappropriately managed device being a given one of the devices that is determined by the management state determination section to be not appropriately managed, the inappropriately managed device's group being a group to which the inappropriately managed device belongs, the inappropriately managed device's group administrator being a group administrator of the inappropriately managed device's group, and
the management state notification section sends the inappropriate management notification to, as the specified address, an address of the inappropriately managed device's group administrator identified by the group management section.

3. The device management system according to claim 2, wherein
the group management section manages device administrators who are administrators of the devices,
the group management section identifies an inappropriately managed device administrator who is a device administrator of the inappropriately managed device,
in a situation in which the inappropriately managed device administrator is a different person from the inappropriately managed device's group administrator, the management state notification section sends the inappropriate management notification to, as the specified address, an address of the inappropriately managed device's group administrator, and
in a situation in which the inappropriately managed device administrator is the same person as the inappropriately managed device's group administrator, the management state notification section performs a process different from that to be performed in a situation in which the inappropriately managed device administrator is a different person from the inappropriately managed device's group administrator.

4. The device management system according to claim 2, wherein
the group management section manages a hierarchical structure of the groups,
the group management section identifies a higher group administrator who is a group administrator of a higher group to which the inappropriately managed device's group belongs, and
upon the management state determination section still determining that the inappropriately managed device is not appropriately managed even after the management state notification section has sent the inappropriate management notification to the address of the inappropriately managed device's group administrator a specified number of times, the management state notification section sends the inappropriate management notification to, as the specified address, an address of the higher group administrator identified by the group management section.

5. The device management system according to claim 1, further comprising
a group management section configured to manage the devices, groups to which the devices belong, group administrators who are administrators of the groups, and a hierarchical structure of the groups, wherein
the group management section identifies a higher group administrator who is a group administrator of a group higher than an inappropriately managed device's group to which an inappropriately managed device belongs, the inappropriately managed device being a given one of the devices that is determined by the management state determination section to be not appropriately managed, the inappropriately managed device's group being a group to which the inappropriately managed device belongs, and
the management state notification section sends the inappropriate management notification to, as the specified address, an address of the higher group administrator identified by the group management section.

6. The device management system according to claim 4, wherein
the management state notification section includes in the inappropriate management notification a device transfer instruction accepting section for accepting an instruction to change the group to which the inappropriately managed device belongs from the inappropriately managed device's group to the higher group, and
upon the instruction being accepted at the device transfer instruction accepting section, the group management section changes the group to which the inappropriately managed device belongs from the inappropriately managed device's group to the higher group.

7. An automatic device management system comprising:
the device management system according to claim 1; and
a control system configured to control the device management system, wherein
the device management system further includes a group management section configured to manage the devices, groups to which the devices belong, and a hierarchical structure of the groups,
upon the management state determination section determining that a given one of the devices is not appropriately managed, the device management system sends the inappropriate management notification to the control system instead of sending the inappropriate management notification to the specified address, and
upon receiving the inappropriate management notification, the control system causes the group management section to change a group to which an inappropriately managed device belongs from an inappropriately managed device's group to a higher group, the inappropriately managed device being the given one of the devices, the inappropriately managed device's group being a group to which the inappropriately managed device belongs, the higher group being a group to which the inappropriately managed device's group belongs.

8. An automatic device management system, comprising:
a device management system configured to manage a plurality of devices; and
a control system configured to control the device management system,
the device management system including:
a management state determination section configured to determine whether or not each of the devices is appropriately managed based on information from an application for managing the devices; and
a group management section configured to manage the devices, groups to which the devices belong, and a hierarchical structure of the groups, wherein
upon the management state determination section determining that a given one of the devices is not appropriately managed, the control system causes the group management section to change a group to which an inappropriately managed device belongs from an inappropriately managed device's group to a higher group, the inappropriately managed device being the given one of the devices, the inappropriately managed device's group being a group to which the inappropriately managed device belongs, the higher group being a group to which the inappropriately managed device's group belongs.

9. The automatic device management system according to claim 8, wherein
upon causing the group management section to change the group to which the inappropriately managed device belongs, the control system causes a plurality of specific systems other than the device management system to perform a plurality of specific processes according to the change in the group to which the inappropriately managed device belongs by the group management section.

10. The automatic device management system according to claim 9, wherein
at least one of the specific systems is a contract management system configured to manage contract details for management of the inappropriately managed device, and
upon causing the group management section to change the group to which the inappropriately managed device belongs, the control system causes, as at least one of the specific processes, the contract management system to make a change in the contract details according to the change in the group to which the inappropriately managed device belongs by the group management section.

11. The automatic device management system according to claim 10, wherein
at least one of the specific systems is an accounting system configured to manage fees according to the contract details, and
upon causing the contract management system to make a change in the contract details, the control system causes, as at least one of the specific processes, the accounting system to make a change in the fees according to the change in the contract details by the contract management system.

12. The automatic device management system according to claim 8, wherein
upon the management state determination section determining that a given one of the devices is not appropriately managed, the control system causes the group management section to change the group to which the inappropriately managed device belongs according to information acquired from one of a plurality of specific systems other than the device management system.

13. The automatic device management system according to claim 12, wherein
at least one of the specific systems is a contract information management system configured to manage contract information of an administrator of the inappropriately managed device's group, and
upon the management state determination section determining that a given one of the devices is not appropriately managed and in a situation in which the contract information acquired from the contract information management system includes specific information, the control system causes the group management section to change the group to which the inappropriately managed device belongs.
